(19) United States
(12) Patent Application Publication
(10) Pub. No.: US 2008/0220542 A1
(43) Pub. Date: Sep. 11, 2008

(54) LOW-FIRE FERROELECTRIC MATERIAL

(76) Inventors: Adolph L. Micheli, Harrison Twp., MI (US); Joseph V. Mantese, Manchester, CT (US); Norman W. Schubring, Troy, MI (US)

Correspondence Address: CANTOR COLBURN, LLP, 20 Church Street, 22nd Floor, Hartford, CT, 06103, US

(21) Appl. No.: 11/682,974

(22) Filed: Mar. 7, 2007

(51) Int. Cl. H01B 1/02

(52) U.S. Cl. 438/3; 252/519.13

(57) ABSTRACT

A low-fire ferroelectric composition, includes a lead bismuth titanate compound having a formula represented by: (Bi₂O₂)ₓ²⁺(Mₘ₋₁TiₘO₃ₘ₋₁)ₓ²⁻ wherein in represents a number 1 through 5, M represents a combination of bismuth and lead, and x represents a number of cations and anions present in the compound, and a eutectic mixture of lead oxide and bismuth oxide.

### BACKGROUND

The present application relates to ferroelectric materials and, more particularly, to a low-fire ferroelectric material suitable for use with complementary metal-oxide semiconductor (CMOS) integrated circuits having aluminum interconnects and/or electrodes.

A ferroelectric capacitor generally comprises a conductive bottom electrode, a ferroelectric film, and a conductive top electrode. Examples of ferroelectric materials include, but are not limited to, SrBi₂Ta₂O₉ (SBT), lead zirconate titanate (PZT), and bismuth lanthanum titanate (BLT). Of these, SBT is one of the most commercially successful materials. The formation of a crystalline ferroelectric film typically requires high temperature (750 degrees Celsius (° C.) or higher for SBT) treatment in oxygen and can be prepared by different techniques, such as spin-coating, physical vapor deposition (PVD), chemical vapor deposition (CVD), metal organic chemical vapor deposition (MOCVD), and the like.

Present integrated circuit designs use CMOS technology with aluminum interconnects and/or electrodes. The surface of an integrated circuit memory is generally includes p-type and n-type regions that must be contacted and interconnected. During the metallization step in the fabrication process, the various regions of each circuit element are contacted and proper interconnection of the circuit elements is made. Aluminum is commonly used for metallization since it adheres well to silicon and to silicon dioxide if the temperature is raised briefly to about 400° C. to 450° C. after deposition.

The use of aluminum for the circuit interconnects limits post-metallization processing steps to temperatures of less than 600° C. Because SBT sinters at 750° C. or higher, it cannot be used with aluminum metallization. Consequently, refractory metal metallization must be integrated with the CMOS process to produce ferroelectric random access memory (FRAM) devices with SBT. This increases the cost and decreases the utility of using ferroelectric materials in FRAMs and other devices.

Accordingly, there remains a need for a low-fire ferroelectric material that can be used with conventional aluminum CMOS metallization.

### BRIEF SUMMARY

Disclosed herein are low-fire ferroelectric compositions and thin films that is compatible with CMOS technologies for applications such as ferroelectric memory devices. It is to be understood, however, that the low-fire ferroelectric compositions as disclosed herein are not limited to a particular application; rather the use of these materials can be suitable for any application known to those skilled in the art.

In one embodiment, a low-fire ferroelectric composition, includes a lead bismuth titanate compound having a formula represented by: (Bi₂O₂)ₓ²⁺(M₋₁TiₘO₃ₘ₊₁)ₓ²⁻ wherein m represents a number 1 through 5, M represents a combination of bismuth and lead, and x represents a number of cations and anions present in the compound, and a eutectic mixture of lead oxide and bismuth oxide.

In another embodiment, a low-fire ferroelectric composition includes a lead bismuth titanate compound having the formula represented by (Bi₂O₂)ₓ²⁺(M₂₋₁TiₘO₃ₘ₊₁)ₓ²⁻ wherein m is 3.33, M represents a combination of bismuth and lead, and x is 3, and a eutectic mixture of lead oxide and bismuth oxide, wherein the eutectic mixture comprise about 8 mole percent to about 16 mole percent of lead oxide.

A ferroelectric memory device includes a thin film comprising a lead bismuth titanate compound having a formula represented by: (Bi₂O₂)ₓ²⁺(Mₘ₋₁TiₘO₃ₘ₊₁)ₓ²⁻ wherein m represents a number 1 through 5, M represents a combination of bismuth and lead, and x represents a number of cations and anions present in the compound, and a eutectic mixture of lead oxide and bismuth oxide.

The above described and other features are exemplified by the following figures and detailed description.

### BRIEF DESCRIPTION OF THE DRAWINGS

Refer now to the figures, which are exemplary embodiments, and wherein like elements are numbered alike:

FIG. 1 illustrates a powder X-ray diffraction pattern of a ferroelectric (PbBi₁₂Ti₁₀O₃₉ with excess Bi₂O₃) thin film composition fired at 500° C.;

FIG. 2 illustrates a powder X-ray diffraction pattern of a ferroelectric (PbBi₁₂Ti₁₀O₃₉ with excess Bi₂O₃) thin film composition with eutectic (Bi₂O_{3˜}PbO) layers fired at 450° C.;

FIG. 3 is a graph illustrating a hysteresis curve for a low-fire ferroelectric (PbBi₁₂Ti₁₀O₃₉ with excess Bi₂O₃) thin film capacitor fired at 500° C.;

FIG. 4 is a graph illustrating a hysteresis curve for a low-fire ferroelectric (PbBi₁₂Ti₁₀O₃₉ with excess Bi₂O₃) thin film capacitor fired at 500° C. with eutectic (Bi₂O₃-PbO) layers;

FIG. 5 is a graph illustrating a hysteresis curve for a general ferroelectric capacitor; and

FIG. 6 illustrates a partial cross-sectional view of a generic ferroelectric random access memory (FRAM) cell having a low-fire ferroelectric capacitor.

### DETAILED DESCRIPTION

Disclosed herein is a ferroelectric material capable of crystallizing into a ferroelectric state at a temperature of less than about 550° C. In contrast to commercially available ferroelectric materials, such as strontium bismuth tantalite (SBT), the disclosed low-fire ferroelectric material is compatible with conventional CMOS processes using aluminum metallization. The low-fire ferroelectric compositions and thin films that are compatible with CMOS technologies are suitable for many applications including, but not limited to, ferroelectric memory devices, and the like. Present integrated circuit designs with aluminum interconnects are limited in their post-aluminum metallization processing Essentially, all processing done to the integrated circuits after the aluminum interconnects are established most occur at temperatures of less than about 600° C. in order to prevent damage to the interconnects. Unlike SBT, which fires at 750° C. or higher, the disclosed ferroelectric material advantageously fires at temperatures of less than about 550° C., thereby allowing it to be used in post-aluminum metallization processing.

As used herein the term “fire” is used to refer to the sintering or annealing of the ferroelectric material into a ferroelectric state. Likewise, the term “low-fire” is used to refer to the ability of the disclosed ferroelectric material to anneal at temperatures below about 550° C. Furthermore, as used herein, the terms “first”, “second”, and the like do not denote nay order or importance, but rather are used to distinguish one element from another, and the terms “the”, “a”, and “an” do not denote limitation of quantity, but rather denote the presence of at least one of the referenced item. The modifier “about” used in connection with a quantity is inclusive of the stated value and has the meaning dictated by context, (e.g., includes the degree of error associated with measurement of the particular quantity). Additionally, all ranges directed to the same quantity of a given component or measurement is inclusive of the endpoints and independently combinable.

The low-fire ferroelectric composition comprises a lead bismuth titanate compound (PBT) with a low-melting eutectic mixture. Ferroelectrics are analogous to ferromagnetic materials: just as the ferromagnetic material in a bar magnet can be permanently magnetized by applying a sufficiently strong magnetic field to it, and will thereafter act independently as a magnet, so a ferroelectric can acquire a fixed voltage gradient when a sufficiently strong electric field is applied to it. Bismuth-containing ferroelectrics, such as PBT, have attracted considerable attention for use in nonvolatile memories because of their intrinsic low operating field, high switching speed, and excellent endurance. In general, bismuth-layered ferroelectrics possess a large polarization along one crystallographic axis, but virtually no polarization alone another crystallographic axis, meaning that they have highly anisotropic properties. (An “anisotropic” property of a material is one which depends on the orientation of the material. For example, wood is anisotropic, in that it splits more easily with the grain than across the grain.) Therefore, the ferroelectric properties (spontaneous polarization, coercive field, dielectric constant) are strongly dependent on the orientation of the films with respect to the underlying substrate materials.

Disclosed herein is the low-fire ferroelectric composition, which is a bismuth layered ferroelectric compounds having the generic formula:

(Bi₂O₂)ₓ²⁺(Mₘ₋₁RₘO₃ₘ₊₁)ₓ²⁻

wherein M is a combination of lead (Pb) and bismuth (Bi), x can be any number and is representative of the number of cations and anions per unit cell, and m can be any number (integer or non-integer) between 1 and 5, wherein m is the number of oxygen octahedra per unit cell. In an exemplary embodiment m equals 3.33 and x equals 3, and the formula for the ferroelectric compound is PbBi₁₂Ti₁₉O₃₉. This particular PBT compound can be attained by combining bismuth titanate (Bi₄Ti₃O₁₂) and lead titanate (PbTiO₃) in a 3 to 1 molar ratio and includes an excess of bismuth. A low-melting eutectic mixture can then be added to the PBR compound to form the low-fire ferroelectric composition.

The eutectic mixture comprises a mixture of two phases, wherein the phases are lead oxide (PbO) and bismuth oxide (Bi₂O₃). The PbO phase can comprise about 8 mole percent (mol %) to about 16 mol % of the eutectic mixture. The Bi₂O₃ phase comprises the balance of the eutectic mixture, i.e., about 84 mol % to about 92 mol %. When the eutectic mixture is added to the above described PBT ferroelectric compound, the eutectic mixture inhibits the formation of pyrochlore, i.e., Bi₂Ti₂O₇. In an exemplary embodiment, no pyrochlore is formed.

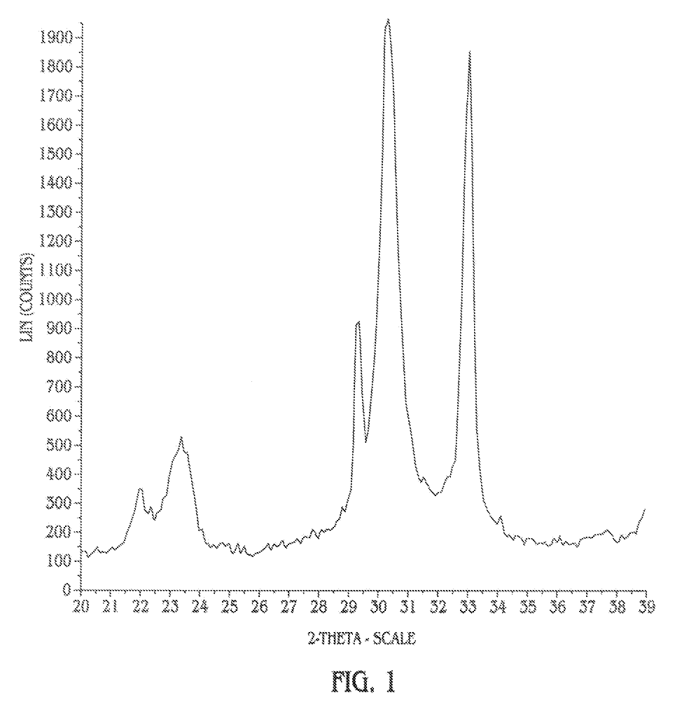

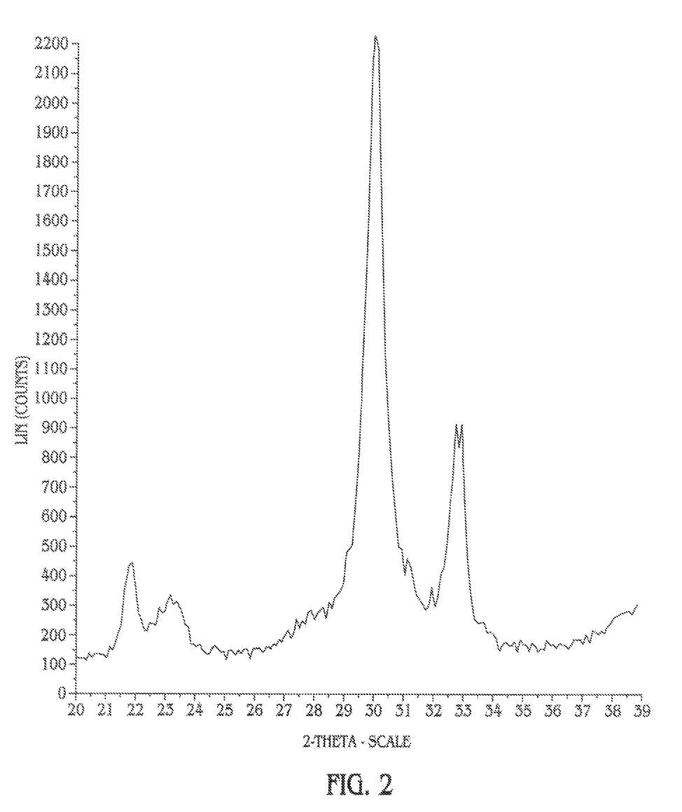

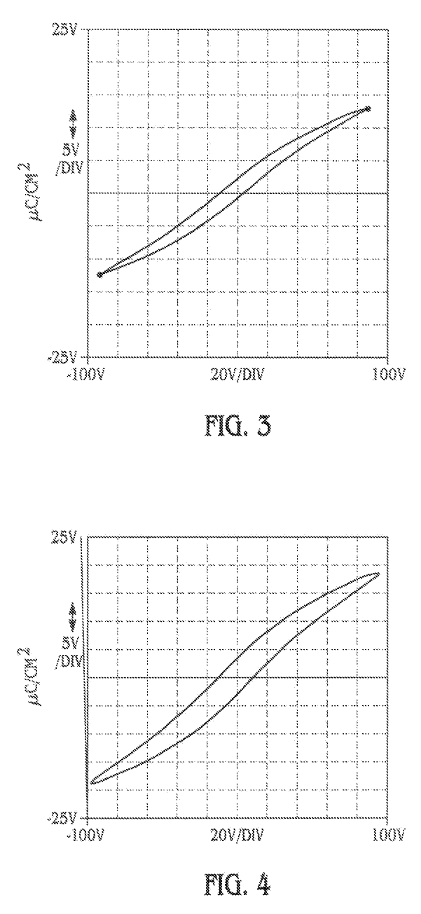

FIGS. 1 and 2 are powder X-ray diffraction patterns illustrating the difference between the PBT compound and the low-fire ferroelectric composition having the eutectic mixture. FIG. 1 is a powder X-ray diffraction pattern of PbBi₁₂Ti₁₀O₃₉ with the excess bismuth, when fired at 500° C. FIG. 2 shows the powder X-ray diffraction pattern of the PbBi₁₂Ti₁₀O₃₉ composition combined with the eutectic mixture when fired at 450° C. The eutectic mixture inhibits the pyrochlore formation in the composition and permits the composition to be fired at 450° C. Without the eutectic mixture, the presence of the phases in the X-ray diffraction pattern wouldn't be as evident for the same PBT compound fired at the 450° C. temperature. The low-fire ferroelectric composition, as described, advantageously crystallizes into a ferroelectric state at a temperature less than or equal to about 550° C., thereby making it a useful ferroelectric composition with post-aluminum CMOS processes. Moreover, as can be seen in FIGS. 3 and 4, the eutectic mixture enhances the ferroelectric properties of the low-fire ferroelectric composition over the PbBi₁₂Ti₁₀O₃₉ alone.

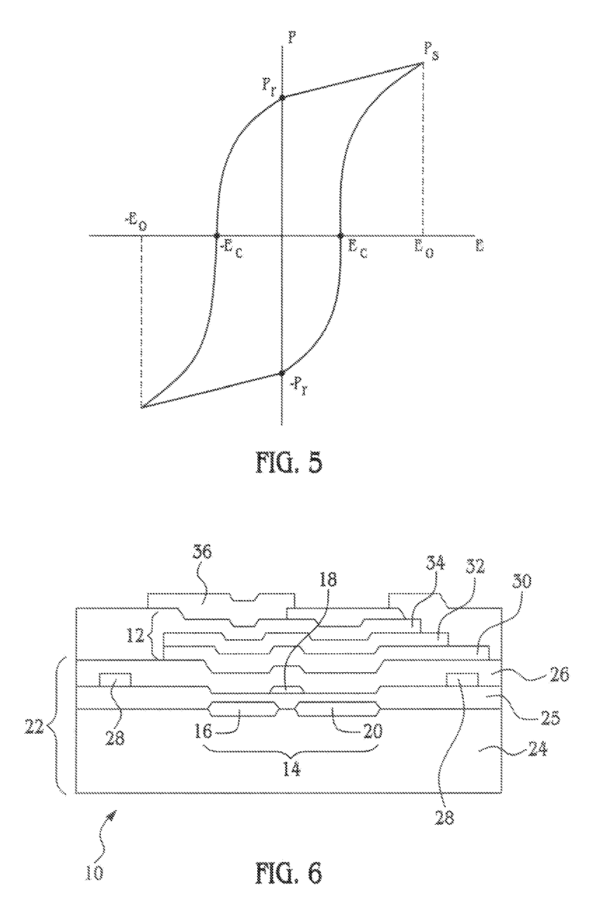

For ease in discussion and reference, a hysteresis curve for a general ferroelectric material is shown in FIG. 5. In this hysteresis curve, electric field strength, E (e.g., in units of kV/cm) is represented on the horizontal axis, and charge density, P (e.g., units of μC/cm²) is represented on the vertical axis. The charge density P increases as the electric field density is increased. After application of an electric field E_{c} to the ferroelectric material, the polarization reaches a corresponding saturation level, Pₛ. When the field is decreased to zero level, a remnant polarization, Pᵣ, remains in the material. Similarly, a remnant polarization, −Pᵣ, in the opposite direction can be created in the ferroelectric material by applying an electric field, −Eₒ, in the opposite direction. The remnant polarization, Pᵣ, is reduced to zero by applying an electric field with opposite polarity called the coercive field, −E_{c}. Similarly, the remnant polarization, −Pᵢ, is reduced to zero by applying an electric field with opposite polarity, E_{c}. As a result of remnant polarization in the ferroelectric material, an electric field is exerted on the volume surrounding the material. The electric field that develops in accordance with the remnant polarization Pᵣ or −Pᵣ can be applied to a device, which can be connected in series to the ferroelectric material.

The charge density characteristics of the low-fire ferroelectric composition as a function of electric field are shown in FIG. 4. The hysteresis curve of the composition is advantageously similar to a hysteresis curve for a ferroelectric composition when fired at higher temperatures. As will be know to those skilled in the art, the larger hysteresis loop in FIG. 4 indicates enhanced charge density properties for the low-fire ferroelectric with the eutectic mixture over existing ferroelectrics, such as PZT, or even the PBT ferroelectric alone (as shown in FIG. 3). Moreover, as can be seen in FIG. 4, the low-fire ferroelectric-eutectic composition has the enhanced ferroelectric properties (better squareness ratio and higher polarization) when sintered at temperatures as low as about 450° C.

The low-fire ferroelectric composition can be formed by any method. In one embodiment, the low-fire ferroelectric composition can be made by spin-coating layers onto a substrate. Spin-coating is a process that uses a solvent suspension, where an excess amount of the solvent is placed on the substrate. The substrate is then rotated at high speed in order to spread the fluid of the suspension by centrifugal force. Rotation is continued while the fluid spins off the edges of the substrate, until the desired thickness of the ferroelectric material thin film is achieved. In this particular embodiment, lead, bismuth, and titanium precursors are dispersed or suspended in xylene or other suitable solvent systems in the appropriate ratios according to the desired PBT composition, e.g., PbBi₁₂Ti₁₀O₃₉. The metal-organic solution is spun at high speed, e.g., 4000 revolutions per minute (rpm) onto the platinized-silicon wafer. The PbBi₁₂Ti₁₀O₃₉ coat is pyrolyzed between 450 and 500° C. The low-melting eutectic mixture having the desired ratio of the PbO and Bi₂O₃ phases is then spun onto the PbBi₁₂Ti₁₀O₃₉ coat. The resultant low-fire ferroelectric composition is annealed, i.e., fired, at about 500° C. to about 550° C. for about 1 to about 6 hours until the film crystallizes into a ferroelectric state. Multiple spin coats or layers can be spun onto the substrate to achieve the desired film thickness. Moreover, the PBT compound and eutectic mixture can be spun on in different variations. For example, two spin coats of the PBT compound can be added for every one coat of eutectic mixture. In another example, three coats of PBT per one coat of eutectic can be used. And in yet another example, the ratio of PBT layers to eutectic layers can be 1 to 1. Regardless of the number of coats, multiple layers of the low-fire ferroelectric composition can exist, such that the eutectic mixture is interlaced with a series of the PBT ferroelectric layers throughout the low-fire ferroelectric thin film.

While the low-fire ferroelectric thin film as described above can be formed using spin-coating, it is to be understood that the low-fire ferroelectric thin film can also be formed by any appropriate deposition method known to those skilled in the art. For example, other spin-coating techniques can include sol-gel spin coating, sputtering, ebeam evaporation, PECVD, and the like. The low-fire ferroelectric thin film can also be formed by, but is not limited to, methods such as chemical vapor deposition (CVD), metal organic CVD (MOCVD), physical vapor deposition (PVD), radio frequency sputtering, liquid phase epitaxy, and the like. In each method, the process can be controlled to achieve the desired film thickness. For example, in the case of spin-coating, the number of spin coats can be adjusted to give the desired ferroelectric film thickness. The low-fire ferroelectric thin film can have any appropriate desired thickness. In one embodiment, for example, the thin film can have a thickness of about 10 nanometers (nm) to about 10 micrometers (μm).

In an exemplary embodiment, the low-fire ferroelectric composition can take the form of a thin-film for use as a capacitor in a semiconductor memory cell, such as a FRAM. The low-fire ferroelectric material can be deposited on a semiconductor substrate, such as a platinized-silicon wafer. In FIG. 6, a generic FRAM cell 10 using a ferroelectric capacitor as a storage capacitor, is schematically illustrated. While a memory cell using ferroelectric capacitors can take a number of forms, the structure and operation of the FRAM 10, as shown in FIG. 6, will be briefly described to attain a better overall understanding of the present invention.

The FRAM cell 10 comprises a ferroelectric capacitor 12 and a selection transistor 14. The transistor 14 comprises a source 16, a gate 18, and a drain 20. The transistor can be disposed in CMOS base layers 22, which can comprise a semiconductor substrate 24, a diffusion barrier layer 25, and an insulating layer 26. The insulating layer can further include aluminum interconnects 28. The ferroelectric capacitor 12 is disposed on top of the CMOS base layers 22 and comprises a conductive bottom electrode 30, a low-fire ferroelectric thin film 32, and a conductive top electrode 34. A second aluminum interconnect 36 can be disposed on top of the ferroelectric capacitor 12.

In fabrication of the ferroelectric capacitor 12, the low-fire ferroelectric thin film 32 is sandwiched between the top electrode 34 and the bottom electrode 30. Suitable materials for the two electrodes include noble metals, such as platinum, and conductive electrode materials such as IrO₂ and RuO₂. In a specific embodiment, the top electrode 34 and the bottom electrode 30 comprise aluminum. In this manner, the top and bottom electrodes are conductive and an electrical signal can be conveyed to the low-fire ferroelectric thin film 32 in order to program the FRAM cell 10.

As stated above, the low-fire ferroelectric thin film 32 can comprise multiple layers. In one embodiment, for example, the low-fire ferroelectric thin film can comprise an interlaced series of the low-melting eutectic mixture and the PBT ferroelectric layers. In other embodiments, the low-fire ferroelectric composition can be layered with other ferroelectric compositions, such as PZT, SBT, BLT, and the like. Moreover, the low-fire ferroelectric composition can be layered with bismuth titanate, lead titanate, lead bismuth titanate, sodium bismuth titanate, and the like. The use of multilayer and different compositions will depend on the characteristics desired for a given application and will be known to those skilled in the art. Regardless of the ferroelectric thin film composition, however, the included low-fire ferroelectric composition advantageously permits use of the capacitor 12 with aluminum CMOS metallization.

A generalized process flow suitable for fabricating the FRAM cell 10 is outlined below, but it is to be understood that the fabrication of the memory cell is not limited to this process sequence. Those skilled in the art will appreciate that the FRAM cell can be fabricated by any suitable method. The starting point for the process is to fabricate conventional CMOS circuitry and plug structures (tungsten, titanium tungsten, poly-silicon, or other like refractory metals), and planarize using conventional silicon processing technologies. The bottom aluminum electrode 30 can then be sputter deposited on the CMOS base layers 22. The CMOS base layers 22 include aluminum interconnects 28 that are deposited in a metallization step. This step is followed by depositing the low-fire ferroelectric thin film 32 by any of the above listed processes, such as MOCVD. The thin film is then pyrolized and subsequently fired at a temperature of less than or equal to about 550° C. The top aluminum electrode 34 is then deposited on the low-fire ferroelectric thin film 32. The FRAM cell 10 can be further fabricated using standard processing steps, such as performing photolithography, etching the capacitor and/or vias, removing photoresist using an ash process, depositing a TiO₂ sidewall diffusion barrier, depositing an interlayer dielectric. A second aluminum interconnect 36 can then be deposited in another metallization step, wherein the aluminum interconnect 36 can be multilayered. The aluminum interconnect can then undergo photolithography using the metallization pattern and etching.

Advantageously, as mentioned above, the low-fire ferroelectric composition is compatible with circuit designs using aluminum interconnects and/or electrodes in conventional CMOS metallization. By combining PBT with the low-melting eutectic mixture, the resultant low-fire ferroelectric composition is able to fire into a ferroelectric state at temperatures lower than existing ferroelectric compositions. Because the low-fire ferroelectric composition can be fired at temperatures less than or equal to about 550° C., it is compatible with post-aluminum processes. Moreover, the low-melting eutectic mixture, comprising Bi₂O₃—PbO, enhances the ferroelectric properties of the composition. The ferroelectric properties have been shown to withstand a large number of switching cycles (greater then 1×10¹⁰) without evidence of degradation in hysteresis quality, making the low-fire ferroelectric composition useful for FRAM applications, as well as other devices requiring ferroelectric materials.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A low-fire ferroelectric composition, comprising:
a lead bismuth titanate compound having a formula represented by:
(Bi₂O₂)ₓ²⁺(Mₘ₋₁TiₘO₃ₘ₊₁)ₓ²⁻
wherein m represents a number 1 through 5, M represents a combination of bismuth and lead, and x represents a number of cations and anions present in the compound; and
a eutectic mixture of lead oxide and bismuth oxide.

2. The low-fire ferroelectric composition of claim 1, wherein a ratio of the lead bismuth titanate compound to the eutectic mixture is about 1:1 to about 3:1.

3. The low-fire ferroelectric composition of claim 1, wherein m is 3.33 and x is 3.

4. The low-fore ferroelectric composition of claim 1, wherein the lead bismuth titanate compound is PbBi₁₂Ti₁₀O₃₉.

5. The low-fire ferroelectric composition of claim 1, wherein the eutectic mixture comprises about 8 mole percent to about 16 mole percent lead oxide.

6. The low-fire ferroelectric composition of claim 1, wherein Pb₂Bi₂O₇ is not present in the low-fire ferroelectric composition.

7. The low-fire ferroelectric composition of claim 1, wherein the composition is adapted for use in a ferroelectric memory device.

8. A low-fire ferroelectric composition, comprising:
a lead bismuth titanate compound having the formula represented by
(Bi₂O₇)ₓ²⁺(Mₘ₋₁TiₘO₃ₘ₊₁)ₓ²⁻
wherein m is 3.33, M represents a combination of bismuth and lead, and x is 3; and
a eutectic mixture of lead oxide and bismuth oxide wherein the eutectic mixture comprise about 8 mole percent to about 16 mole percent of lead oxide.

9. The low-fire ferroelectric composition of claim 8, wherein a ratio of the lead bismuth titanate compound to the eutectic mixture is about 1:1 to about 3:1.

10. The low-fire ferroelectric composition of claim 8, wherein Pb₂Bi₂O₇ is not present in the low-fire ferroelectric composition.

11. The low-fire ferroelectric composition of claim 8, wherein Pb₂Bi₂O₇ is not present in the low-fire ferroelectric composition.

12. The low-fire ferroelectric composition of claim 8, wherein the composition is adapted for use in a ferroelectric memory device.

13. A ferroelectric device, comprising:
a thin film comprising:
a lead bismuth titanate compound having a formula represented by:
(Bi₂O₂)ₓ²⁺(Mₘ₋₁TiₘO₃ₘ₊₁)ₓ²⁻
wherein m represents a number 1 through 5, M represents a combination of bismuth and lead, and x represents a number of cations and anions present in the compound; and
a eutectic mixture of lead oxide and bismuth oxide.

14. The ferroelectric device of claim 13, wherein a ratio of the lead bismuth titanate compound to the eutectic mixture is about 1:1 to about 3:1.

15. The ferroelectric device of claim 13, wherein the lead bismuth titanate compound is PbBi₁₂Ti₁₀O₃₉.

16. The ferroelectric device of claim 13, where m is 3.33 and x is 3.

17. The ferroelectric device of claim 13, wherein the eutectic mixture comprises about 8 mole percent to about 16 mole percent lead oxide.

18. The ferroelectric device of claim 13, wherein Pb₂Bi₂O₇ is not present in the thin film.

19. The ferroelectric device of claim 13, wherein the lead bismuth titanate and the eutectic mixture are alternatingly layered.

20. The ferroelectric device of claim 13, wherein the thin film has a thickness of about 10 nanometers to about 10 micrometers.

21. The ferroelectric device of claim 13, further comprising an aluminum interconnect.

22. The ferroelectric device of claim 13, wherein the thin film is applied by spin-coating.
